(19) United States
(12) Patent Application Publication
(10) Pub. No.: US 2010/0123711 A1
(43) Pub. Date: May 20, 2010

(54) DISPLAY DEVICE

(76) Inventor: Kazuyoshi Kawabe, Yokohama (JP)

Correspondence Address: Raymond L. Owens;Patent Legal Staff, Eastman Kodak Company, 343 State Street, Rochester, NY, 14650-2201, US

(21) Appl. No.: 12/615,302

(22) Filed: Nov. 10, 2009

(30) Foreign Application Priority Data
Nov. 20, 2008 (JP) 2008-296597

(51) Int. Cl. G09G 3/30; G06F 3/038

(52) U.S. Cl. 345/214; 345/76

(57) ABSTRACT

In order to efficiently suppress pseudo contours, a display device has pixels arranged in a matrix arrangement, and performs display by performing digitally driving according to pixel data of an image signal. The driver divides pixel data for a single pixel into corresponding sub-frames as a plurality of bit data, and forms one frame from a specified repeating number of unit frames and digitally drives each pixel by providing the bit data to each pixel. A data analyzing circuit analyzes input data, and analyzes likelihood of occurrence of pseudo contours. A refresh rate control circuit controls the driver based on the analysis results to change a repeating number of unit frames of a single frame.

### CROSS-REFERENCE TO RELATED APPLICATIONS

This application claims priority of Japanese Patent Application No. 2008-296597 filed Nov. 20, 2008 which is incorporated herein by reference in its entirety. Reference is made to commonly-assigned U.S. patent application Ser. No. ______ filed concurrently herewith, entitled “Reducing Pseudo Contours in Display Device” by Kazuyoshi Kawabe, the disclosure of which is incorporated herein.

### FIELD OF THE INVENTION

The present invention relates to a display device for performing display by digitally driving pixels, arranged in a matrix arrangement, according to image data of an image signal.

### BACKGROUND OF THE INVENTION

There has lately been aggressive development of organic EL displays. If an organic EL, which is a self-emissive element, is used in a display, it is advantageous in achieving high contrast, and has high-speed response, which makes it possible to display movies containing rapid motion without causing blurring.

Currently, due to demands for high definition and high resolution, active matrix type displays that have organic EL elements driven by thin film transistors (TFTs) are starting to become mainstream, and are manufactured by forming organic EL elements on a substrate on which low temperature polysilicon TFTs etc. have been formed. Low temperature polysilicon TFTs have high mobility of carriers, such as electrons, and operate stably, which shows that they are suitable as organic EL drive elements, but if there are large variations in characteristics such as threshold value and mobility, and there is a fixed current operation in the saturation region, there will be variation in brightness between pixels, and there is a problem that brightness irregularities appear in the display. For that reason, digital drive has been proposed for reducing display irregularities by operating TFTs in the linear region and using them as switches.

With digital driving, a pixel is controlled to two values, namely whether or not to emit light, and so is made multiple gradation using a plurality of subframes (sub-frame type digital driving), or is made multiple gradation depending on surface area gradation etc. using a plurality of sub-pixels (sub-pixel type digital driving).

### SUMMARY OF THE INVENTION

However, with conventional sub-frame type digital driving it is easy for pseudo contours to arise, and particularly with a still image, it is difficult to control pseudo contours due to high speed line of sight movement. A method for increasing frequency and controlling pseudo contours is disclosed in U.S. Patent Application Publication No. 2005/0212740, but if frequency is increased there is a problem of increased power consumption.

Also, with surface area gradation control using sub-pixels disclosed in U.S. Pat. No. 6,518,941, there is a limit to the number of sub-pixels that can be provided, and there is a problem in that achieving multiple gradations is difficult.

The present invention provides a display device for performing display by digitally driving pixels, arranged in a matrix arrangement, according to image data of an image signal, including: a driver for dividing pixel data for one pixel into corresponding sub-frames as a plurality of bit data, and forming a single frame from a specified number of unit frames and digitally driving each pixel by providing the bit data to each pixel; an analyzing circuit for analyzing the image signal and analyzing likelihood of occurrence of pseudo contours; and a changing circuit for changing a number of unit frames of a single frame, wherein the driver changes the number of unit frames of a single frame based on results of analysis by the analysis section.

It is also possible for the analyzing circuit to compare pixel data of an object pixel and pixel data around that pixel, to determine whether or not it is likely that for pseudo contours will arise.

It is also possible for the analyzing circuit to compare pixel data of an object pixel and pixel data around that pixel for every bit, to determine whether or not it is likely that pseudo contours will arise.

It is also preferable for the analyzing circuit to perform a logical operation on pixel data of an object pixel and pixel data around that pixel for every bit, to determine whether or not it is likely that pseudo contours will arise from whether or not there are a lot of bits that have changed.

It is also preferable for the analyzing circuit to perform weighted addition using bit positions for a number of bits that have changed in the result of the logical operation, and determine whether or not a lot of bits have changed from this result of weighted addition.

It is also preferable for the driver to change a number of unit frames in a step-wise manner, based on results of analysis by the analyzing circuit.

It is also preferable for the driver to change a number of unit frames in a continuous manner, based on results of analysis by the analyzing circuit.

It is also preferable for the driver to stop operation in a period when no lines are selected.

It is also preferable for each pixel to include a plurality of sun-pixels, and for each pixel to be driven in a subframe by different bit data for one pixel.

It is also preferable for the pixel to include an organic EL element. According to the present invention, it is possible to effectively prevent pseudo contours.

### BRIEF DESCRIPTION OF THE DRAWINGS

FIG. 1 is a drawing showing the overall structure of a display device 101 of a first embodiment;

FIG. 2 is a drawing showing the internal structure of a timing control circuit;

FIG. 3 is a drawing showing a pattern with which pseudo contours are likely to occur;

FIG. 4 is a drawing showing light emitting elements of adjacent pixels when driven at four times speed;

FIG. 5A is a drawing showing a threshold value type example of determining occurrence of pseudo contours;

FIG. 5B is a drawing showing a step type example of determining occurrence of pseudo contours;

FIG. 5C is a drawing showing a continuous type example of determining occurrence of pseudo contours;

FIG. 6 is a drawing showing the structure of a pixel;

FIG. 7A is a timing chart for driving a unit frame with four times speed digital driving;

FIG. 7B is a timing chart for driving one frame with four times speed digital driving;

FIG. 8A is a timing chart showing one example of a method of changing a unit frame period;

FIG. 8B is a timing chart showing another example of a method of changing a unit frame period;

FIG. 8C is a timing chart showing yet another example of a method of changing a unit frame period;

FIG. 9 is a drawing showing the structure of a pixel having three sub-pixels arranged with a common select line to form a single pixel;

FIG. 10A is a timing chart of unit frame driving, for carrying out 12-bit gradation display using the pixel of FIG. 9;

FIG. 10B is a timing chart of single frame driving, for carrying out 12-bit gradation display using the pixel of FIG. 9; and

FIG. 11 is a drawing showing the overall structure of a display device containing the pixels of FIG. 9;

### DETAILED DESCRIPTION OF THE INVENTION

Embodiments of the present invention will be described in the following based on the drawings.

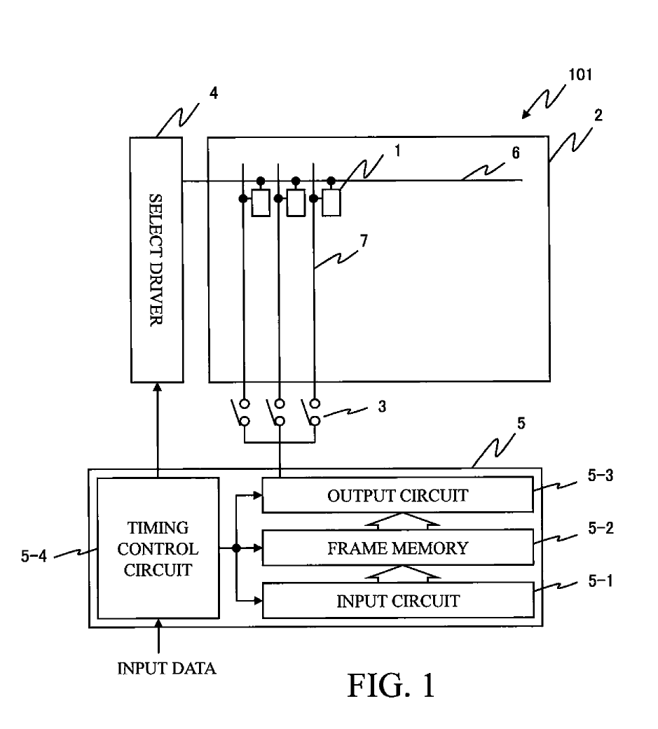

The overall structure of a display device 101 of this embodiment is shown in FIG. 1. The display device 101 includes a pixel array 2 having pixels 1 for generating the each of the colors R (red) G (green) and B (blue) arranged in a matrix, a select driver 4 for selectively driving select lines 6 arranged for each line of pixels 1, a data driver 5 for driving data lines 7 arranged for each column of pixels 1, and a multiplexor 3 for connecting outputs of the data driver 5 to data lines 7 for each of RGB.

Here, a pixel 1 is constructed with three pixels for each of RGB to constitute a full color unit pixel that can give full color, but it is also possible to further include a pixel 1 for emitting W (white) to make a full color unit pixel as RGBW. In this case, a data line 7 for W is further provided in the multiplexor 3. With this example, a stripe type has been adopted where a pixel 1 for one of the colors RGBW is arranged in each row, but it is also possible to use a delta type.

The data driver 5 shown in FIG. 1 is made up of an input circuit 5-1, a frame memory 5-2, an output circuit 5-3, and a timing control circuit 5-4, and operates as a built-in memory type data driver. Dot unit data input from outside is input to the timing control circuit 5-4, control signals are generated according to the input data, and these control signals are supplied to the input circuit 5-1, frame memory 5-2 and output circuit 5-3.

Dot unit data output from the timing control circuit 5-4 is converted to line units by the input circuit 5-1, and stored in line units in the frame memory 5-2. Data stored in the frame memory 5-2 is read out in line units and transferred to the output circuit 5-3. The multiplexor 3 sequentially selects, for example, from R to G to B, and if the respective data lines 7 for RGB are sequentially connected to the output circuit 5-3 corresponding data is output to the respective data lines 7 in the order R to G to B in line units. If the multiplexor 3 is used in this way, the number of outputs of the data driver 5 can be made only the number of full color unit pixels (number of full color unit pixels made up of the three colors of RGB or the four colors of RGBW), which simplifies the structure, and is therefore good for use in a mobile terminal. For example, in the case of a QVGA of 240 by 320, the number of outputs of the data driver 5 amounts to 240 and it is possible to make the circuit scale of the output circuit 5-3 smaller, which is helpful in reducing costs. If the multiplexor 3 were to be omitted, it would be necessary to connect outputs of the data driver 5 to all of the RGB data lines, and 240×3=720 outputs would be required.

The select driver 4 selects a select line 6 for a line on which data is selected, at the time when data is output to the data line 7. In this way, data from the data driver 5 is appropriately written to the pixel 1 of the line in question. Once data is written in, the select driver 4 releases selection of the relevant line, selects the next line to be selected, and repeats this selection and release operation. Specifically, the select driver 4 operates so as to select only one line at a time.

The select driver 4 is more often than not manufactured with low temperature polysilicon TFTs, on the same substrate as the pixels, but it is also possible to provide the select driver 4 as a separately provided driver IC, or to incorporate the select driver 4 into the data driver 5.

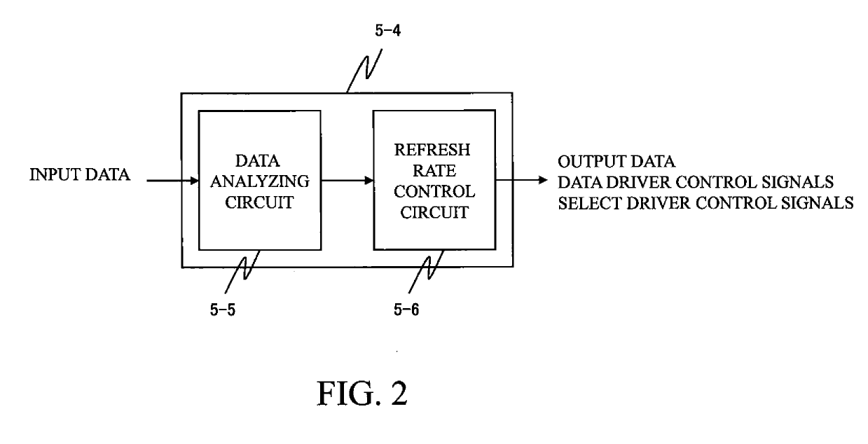

The internal structure of a timing control circuit 5-4 is shown in FIG. 2. Dot unit input data is input to the data analyzing circuit 5-5 inside the timing control circuit 5-4, and what type of data is contained in the image/video is analyzed. Based on the result of this analysis, control signals for generating the optimum refresh rate are output by the refresh rate control circuit 5-6 inside the timing control circuit 5-4. Control signals generated by the refresh rate control circuit 5-6 are supplied to the frame memory 5-2, the output circuit 5-3 and the select driver 4, and the display device 101 displays images at a refresh rate that is appropriate for the image data.

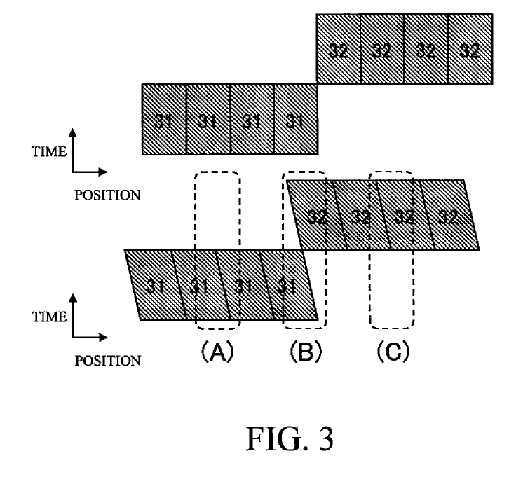

An example of a pattern that is prone to the occurrence of pseudo contours is shown in FIG. 3. This display example contains a critical transition displaying SF0-SF4 with emitted light gradation data “31” and SF5 with emitted light gradation data “32” adjacently, at the time of 6-bit gradation display where each subframe SF0-SF5 is respectively weighted at 1:2:4:8:16:32. In the case where there is no line of sight movement, there is no interference between gradations, as shown at the upper part of FIG. 3, and so pseudo contours do not occur, but with a normal refresh rate of 60 Hz, due to line of sight movement emitted light in adjacent pixels interferes with each other, as shown in the lower part of FIG. 3, and it looks as if gradations that are different from those of a natural display are being displayed.

Specifically, in the case of the lower part of FIG. 3, gradation data “31” is displayed in the region (A), and gradation data “32” is displayed in the region (C), with the appearance being coincident with the upper stage, but in a region (B) where the two interfere with each other gradations that are brighter than they should be appear, and therefore this constitutes a pseudo contour and causes unnatural display.

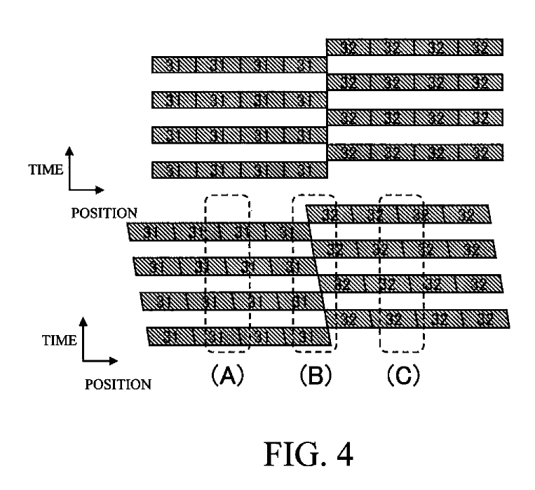

FIG. 4 shows light emitting elements of adjacent pixels when driven at 240 Hz (four times speed), in order to improve this pseudo contour. In the region (B), if the speed becomes a high speed of fours times speed, the time when the two gradations interfere due to line of sight movement becomes short, and so it is possible to suppress pseudo contours. According to tests by the inventor, if display was performed at three to four times speed, it was possible to sufficiently suppress pseudo contours, and so it is understood that if driving is possible at a maximum of four times speed, it is possible to achieve favorable display.

However, in the case of four times speed, the refresh rate becomes four times the normal refresh rate, and there is an increase in the power consumption of the data driver 5. In particular, there is further increase in power consumption when the number of subframes becomes large accompanying multiple gradations, and it is therefore not preferable to always proactively make the speed four times speed.

With this embodiment, a data analysis circuit 5-5 analyzes the extent to which critical transitions are contained in an image, and it is possible to speed up the refresh rate as required using a refresh rate control circuit 5-6.

For example, in the case of displaying mainly textual information, such as a mail screen or menu display, there are many instances where black characters on a white background are used, but in this type of situation there are not a lot of critical transitions, and so it is not necessary to increase to four times speed, and it is acceptable to perform display at the normal refresh rate or at a low speed of double speed. Specifically, it is possible to reduce the power consumption in this type of display situation. However, in cases of graphics display making use of natural images and grayscale, there are a lot of critical transitions, and it is preferable to have high-speed display of three to four times speed. In this type of situation power consumption is high, but it is preferable to perform control so as to further increase speed to maintain high resolution. In this manner it is possible to reduce power consumption of the data driver 5 by varying the refresh rate depending on the display image.

In detecting the critical transitions, it is possible to consider a method as described in the following, for example. It is possible to have a method where respective bit data for each pixel, and for peripheral pixel groups contained to the left and right, above and below, or diagonally next to each pixel, are subjected to respective OR operations, and cases where results of comparison of the original data with the ORed data are significantly different are determined to be critical transitions. For example, consider a case where there is a pixel of gradation data “32 (100000)” in the vicinity of a pixel of gradation data “31 (011111)”. A result of a bit OR operation between the two becomes “63 (111111)”, and thus becomes a difference of about twice that of the original “31”. This constitutes a critical transition with a pseudo contour shown in FIG. 3 appearing very noticeably, and so it will be understood that at the normal refresh rate it is unacceptable. In the case of gradation data of adjacent pixels of “31 (011111)” and “30 (011110)”, the result of the bit OR operation is “31 (011111)” and there is almost no difference from the original data, and so it will be understood that there is no critical transition, and the normal refresh rate is sufficient.

Even in a case where the gradation data for adjacent pixels is not consecutive, such as “33 (100001)” and “30 (011110)”, Since the bit OR operation result becomes “63 (111111)” it constitutes a critical transition, and it is possible to detect critical transitions easily by comparing the bit operation result and data.

It is possible to similarly detect all critical transitions by using bit operations other than the bit OR operation, such as exclusive-or (XOR). In this case, because discrepancies between associated bits are detected, it is possible to detect whether any bit data is different.

It is possible to perform the bit operations for each color of RGB, but it is also possible to detect critical transitions using associated different colors, such as R and adjacent G and adjacent B. Detection can also be performed using wide-ranging pixels two pixels or three pixels apart.

If a critical transition exists even at one pixel between adjacent pixels, pseudo contours will occur with line of sight movement, and so this pixel is counted as a pixel where it is likely that a pseudo contour will occur. If a similar detection process is repeated for all pixels, it is possible to detect the extent to which pixels where critical transitions occur (CT pixels) within the image. CT pixels are calculated in this way in the data analysis circuit 5-5, and what refresh rate digital driving is performed at is determined based on the results of this calculation.

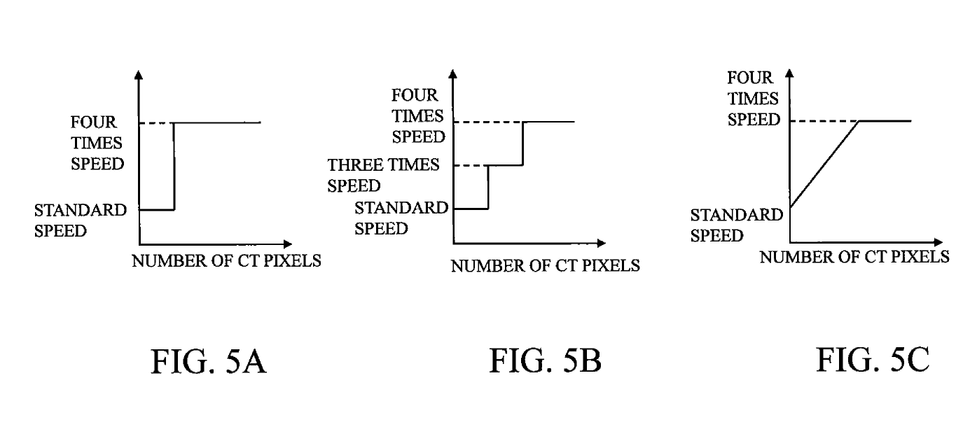

Examples of determination are shown in FIG. 5A to FIG. 5C. With the example of FIG. 5A, control is performed so that if the level of CT pixels exceeds 5% of total pixels, the driving is performed at four times speed, while if the extent of CT pixels is less than or equal to 5% driving is carried out at a low speed of the normal refresh rate, for example, two times speed. Also, with the example of FIG. 5B, the refresh rate is changed in steps, so that with CT pixels at less that 5% the refresh rate is made two times, at 5% or more but less than 10% it is made three times, and above 10% it is made four times. With this step type change in refresh rate, since the refresh rate is a natural number multiple of the basic frequency, it is very convenient in cases where the refresh rate is fixed, such as movies.

Further, FIG. 5C shows a continuous type of situation were the refresh rate is continuously controlled. Specifically, the refresh rate is not a natural number multiple, and can be, for example, 2.8 times or 3.2 times depending on the number of CT pixels. In the case of continuous control of refresh rate, besides a method of comparing the number of CT pixels and increasing the refresh rate, it is also possible to increase the refresh rate in a non-linear way such as in accordance with a quadratic function or an exponential function.

The number of CT pixels and refresh rate conversion method as in FIG. 5A to FIG. 5C are registered in the data analysis circuit 5-5 using a look up table or the like constructed of registers etc., and can be arbitrarily set.

It will also be understood that the extent of pseudo contours whose occurrence is anticipated at the critical transitions will be different depending on the bit data. Specifically, with gradation data “31” and “32” with related MSB, it is easy for prominent pseudo contours to arise, but with gradation data “15” and “16” the likelihood is somewhat less. It is possible to reflect differences in extent in this way, make the anticipated pseudo contours a numerical value, and change the refresh rate based on this numerical value. For example, a weighting factor W5 is assigned to a number of CT pixels N5 caused by data in the vicinity of gradation data “32”, W4 is assigned to a number of CT pixels N4 caused by data in the vicinity of gradation data “16”, with gradation data “8”, W3 is assigned to a number of CT pixels N3, with gradation data “4” W2 is assigned to a number of CT pixels N2, and with gradation data “2” W1 is assigned to a number of CT pixels N1. An inequality W5>W4>W3>W2>W1 is established, and degree of pseudo contours for an image P=W5×N5+W4×N4+W3×N3+W2×N2+W1×N1 is defined, and by appropriately setting W1 to W5 it is possible to calculate degrees of pseudo contours corresponding to extent of critical transitions.

Using weighting calculation refresh rate conversion is then carried out based on the degree of pseudo contours with the threshold scheme, step scheme or continuous scheme, and it is possible to efficiently suppress pseudo contours. However, in order to estimate the extent of pseudo contours, it is possible to change the refresh rate using a method other than the previously described number of CT pixels and extent of pseudo contours.

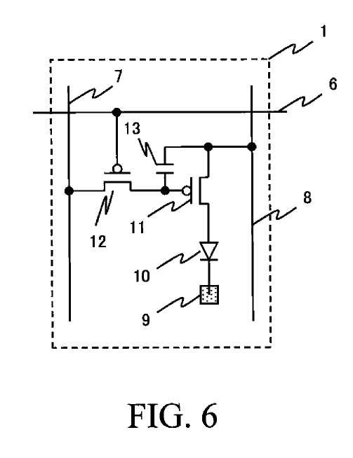

The structure of a pixel 1 is shown in FIG. 6. As shown, the pixel 1 is made up of an organic EL element 10, a drive transistor 11, a select transistor 12, and a storage capacitor 13. An anode of the organic EL element 10 is connected to a drain terminal of the drive transistor 11, while the cathode of the organic EL element 10 is connected to a cathode electrode 9 common to all pixels. A source terminal of the drive transistor 11 is connected to a power supply line 8 common to all pixels, while the gate terminal is connected to one terminal of the storage capacitor 13 having its other terminal connected to the power supply line 8, and to a source terminal of the select transistor 12, and the gate terminal of the select transistor 12 is connected to the select line 6, with the drain line being connected to a data line 7. However, the power supply line 8, and cathode electrode 9 are omitted from the overall structural diagram.

If the select line 6 is selected (made Low) by the select driver 4, the select transistor 12 conducts, and a data potential supplied to the data line 7 is fed to the gate terminal of the drive transistor 11, to perform on/off control of the drive transistor 11. For example, when the data potential on the data line 7 is Low, the drive transistor 11 is conductive, and current flows into the organic EL element 10 to emit light, while when the data potential is High the drive transistor 11 is off, current does not flow in the organic EL element 10, and it is turned off. Because the data potential brought to the gate terminal of the drive transistor 11 is stored in the storage capacitor 13, even if the select transistor 12 is non-select driven by the select driver 4 (even if the data potential is made High), the on or off operation of the drive transistor 11 is maintained, and the organic EL element 10 continues in a lit state or unlit state until accessed in the next subframe.

In FIG. 6, the drive transistor 11 and the select transistor 12 are p-channel transistors (TFTs), but this is not limiting. Also, in the construction of the pixel 1, it is also possible to adopt various known configurations.

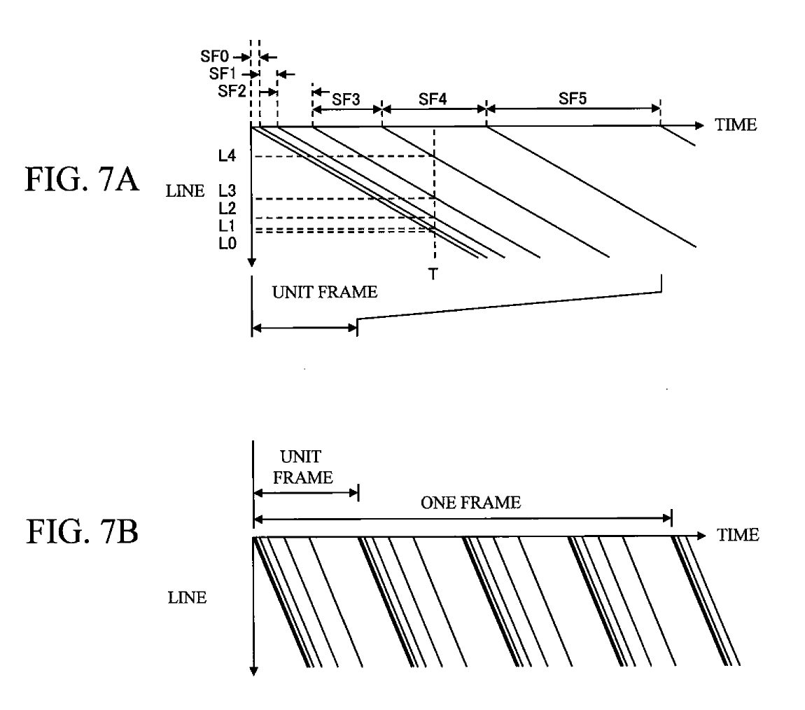

Timing charts for four times speed digital drive are shown in FIG. 7A and FIG. 7B. FIG. 7A shows a subframe structure for a unit frame period capable of 6-bit gradation display using 6 subframes. Specifically, 6-bit gradation display is possible even with unit subframes only. A subframe commences from a lower order bit SF0, and displays six bits once the upper order bit SF5 is concluded. However, it is not necessary for a subframe to be executed from the lower order bit to the higher order bit, and it is possible to have an order of from the higher order bit to the lower order bit, or even in a random order.

In carrying out the driving such as shown in FIG. 7A using the display device of FIG. 1, in a period T a plurality of lines L0 to L4 must be selected in a time multiplexed manner, and control must be carried out so as to write bit data to a line corresponding to that bit data. Specifically, in period T it is necessary to perform time divided selection so that bit 0 is written to line L0, bit 1 is written to line L1, bit 2 is written to line L2, bit 3 is written to line L3, and bit 4 is written to line L4. One example of this type of control method is shown in detail in WO 2005/116971 A1, and so description will be omitted here. If a unit frame period shown in FIG. 7A is, for example, ¼ of a frame period, there will be four unit frames in a single frame, as shown in FIG. 7B, and display at four times speed is carried out. Specifically, it is possible to vary the refresh rate by changing this unit frame period.

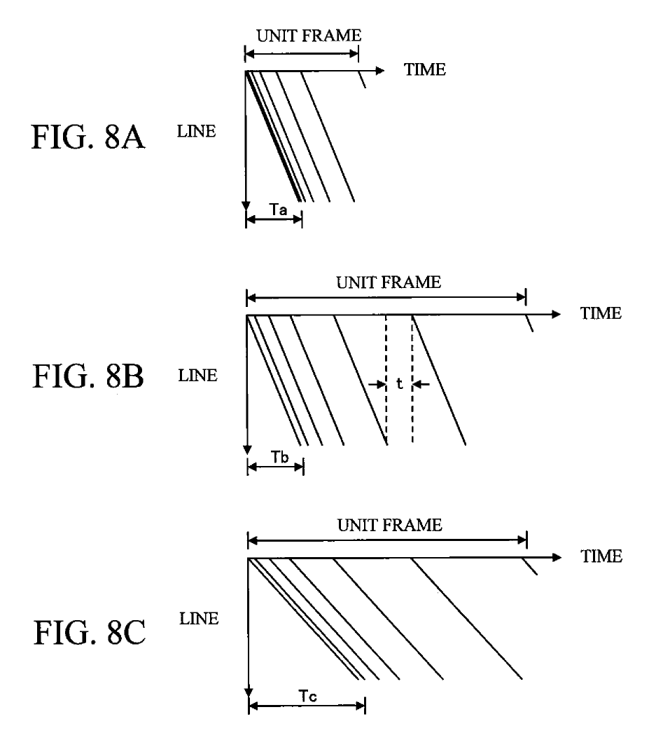

Examples of changing the unit frame period are shown in FIG. 8A to FIG. 8C. If four times speed is made the maximum refresh rate, then the minimum unit frame becomes as shown in FIG. 8A. In the case of lowering the refresh rate, that is, in the case of increasing the unit frame period, it is possible to fix the horizontal period, as in FIG. 8B, maintain the ratios of each of SF0-SF5 at 1:2:4:8:16:32, and widen the interval between each subframe (subframe period expansion method). In this way, since the refresh rate is reduced, power consumption is lowered. Using the subframe expansion method of FIG. 3B, if the subframe interval becomes wide, periods such as period t where no lines are selected appear frequently. In this period, a control signal such as a clock is stopped, and by stopping operations such as the multiplexor 3, select driver 4, data driver 5 and memory access, lowering of power consumption is carried out more efficiently.

It is also possible, to not change the subframe interval, as in FIG. 8C, but expand the horizontal period to widen the unit frame interval (horizontal period expansion method). With the method of expanding the horizontal period, since the horizontal period becomes longer, the time for all lines to complete each subframe becomes longer, but similarly the refresh rate is lowered, and so power consumption is reduced.

By varying the unit frame period in this way, the refresh rate can be easily changed, but it is necessary to consider periods in which the refresh rate shifts in accordance with content of the image. In the case of subframe period expansion, sine the horizontal period is fixed, the time Tb (=Ta) for completion of writing for all lines is the same regardless of the refresh rate, and there is little disturbance of the image with movement. However, with the horizontal period expansion method, the writing period Tc (≠Ta) for all lines is dependent on the refresh rate and will differ. Specifically, with a movement period before and after changing of the refresh rate, a light emitting period will differ between a particular line and another line, making image disturbance likely. It is therefore possible for refresh rate switching to be carried out instantaneously, but it is preferable to carry out processing to change the refresh rate gradually and as smoothly as possible. For example, when the data analysis circuit 5-5 determines so as to switch from two times speed to four times speed, the refresh rate control circuit 5-6 does not switch from two times speed to four times speed in the next frame, but preferably performs control so that in the ensuing frames the refresh rate is changed to a rate between two times and four times speed, for example three times speed, to eventually be changed to four times speed. In the case of not continuously switching the refresh rate, as a result of this kind of control an image that is likely to cause pseudo contours and an image that is not so likely to cause pseudo contours are alternately input, and even if refresh rate is frequently prompted, frequent change in refresh rate due to chattering is inhibited, and it is possible to prevent unnatural display.

This kind of change in driving timing is appropriately carried out by changing data read control signals from the frame memory 5-2, control signals for switching the multiplexor 3, a clock of the select driver 4 etc., and these signals are generated by the refresh rate control circuit 5-6.

Also, in order to efficiently suppress pseudo contours, it is possible to divide, for example, a subframe SF5 having a long light emitting period into a number of subframes. For example, SF5 is divided into two identical periods, and if these are called SF5-1 and SF5-2, data “32” from SF5 is divided into two data “16”. If this is done, data “32” can be expressed as data “16” from SF0-SF4 and data “16” from SF5-1, and so it is possible to alleviate the effects caused by the critical transition. The division of SF5 can be into three or into four periods, and the proportion at which to divide can also be variously set.

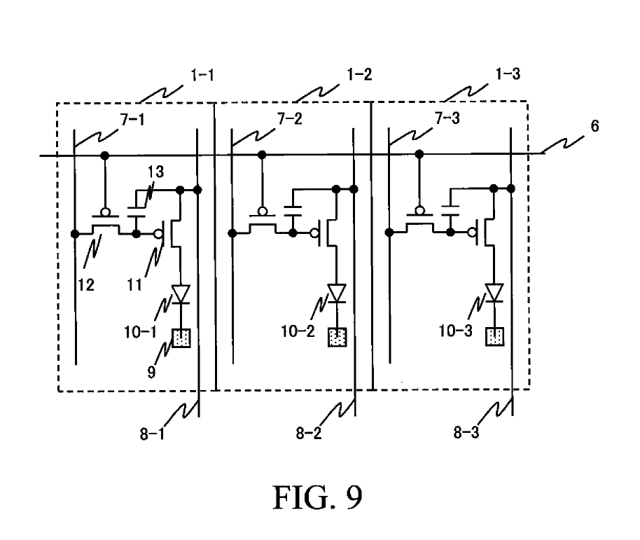

In a situation where the screen size become large and resolution is increased, it is possible to change the refresh rate by using sub-pixels, as described in the following. The pixel of FIG. 9 is an example of a single pixel having three of the pixels 1 of FIG. 6 arranged as sub-pixels, with a select line 6 made common. A sub-pixel 1-1 generates a light intensity corresponding to data of higher order bits, sub-pixel 1-2 generates a light intensity corresponding to data of middle bits, and sub-pixel 1-3 generates a light intensity corresponding to data of lower order bits. To obtain different emitted light intensities between sub-pixels, it is possible to make the light emitting surface area of the organic EL elements 10-1, 10-2 and 10-1 of each of the sub-pixels different, but it is preferable, as shown in FIG. 9, to have an adaptable structure by providing a different power supply line to each sub-pixel, and supplying different power supply potentials, such as VDD1 to the power supply line 8-1 of sub-pixel 1-1, VDD2 to the power supply line 8-2 of sub-pixel 1-2, and VDD3 to the power supply line 8-3 of sub-pixel 1-3. For example, to realize a 12-bit gradation with three sub-pixels, it is possible for each sub-pixel to generate a 12÷3=4-bit gradation. However, because the sub pixel 1-1 corresponding to the upper order bits corresponds to bits 11-8, which are the upper four bits of the 12 bits, the sub pixel 1-2 corresponding to the middle bits corresponds to bits 7-4, which are the next four bits, and the sub pixel 1-3 corresponding to the lower order bits corresponds to bits 3-0, which are the remaining lower four bits, it is necessary to set light intensity ratios for the same light emitting period to 256:16:1. Deriving the maximum 256:1 light intensity ratio using a light emitting surface area ratio is difficult to achieve accurately, and adjustment is not possible after manufacture. It is possible to more easily and accurately adjust light emission intensity ratios with a structure that can set a power supply potential separately for each sub-pixel, as shown in FIG. 9.

By selecting the select line 6 that is common to all sub-pixels, and respectively supplying bit data of one from each of the upper 4-bits, the middle O-bits and the lower 4-bits to the respective data lines 7-1, 7-2 and 7-3 of each sub-pixel, bit data is simultaneously written to three sub-pixels. For example, among the lower 4 bits, if the sub-frame SF2 for bit 2 is commenced, respective data of the upper bit 2 (bit 10), the middle bit 2 (bit 6) and the lower bit 2 (bit 2) are supplied to the data lines 7-1, 7-2 and 7-3, and written to the sub-pixels.

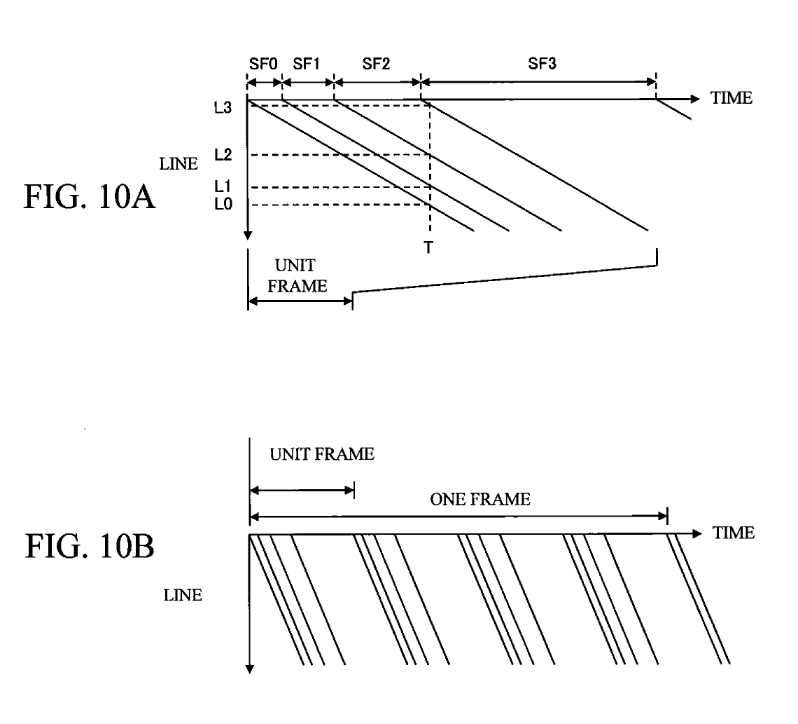

An example of a sub-frame structure for carrying out 12-bit gradation display using the pixel of FIG. 9 is shown in FIG. 10. As described previously, the sub-pixel is constructed from SF0-SF3, having 4-bit gradation, namely having sub-frame periods in a ratio of 1:2:4:8. A unit frame capable of 4-bit gradation display is shown in FIG. 10A, and by repeating the unit frame four times in a single frame period, as shown in FIG. 10B, pseudo contours are suppressed. In order to more efficiently reduce pseudo contours, it is possible to further divide the sub-frame SF3 of the MSB.

Here also, similarly to FIG. 7, in period T lines L0-L3 are selected in a time divided manner, but control is performed so that bit 0 is written to line L0, bit 1 is written to line L1, bit 2 is written to line L2, and bit 3 is written to line L3.

Also, as shown in FIG. 9, by providing a plurality of sub-pixels 1-1, 1-2, 1-3 with a select line 6 made common to them all, it is possible to transfer bit data to data lines 7-1, 7-2 and 7-3 in a single frame. Accordingly, it is possible to achieve multiple gradation while reducing the number of sub-frames. In this case, it is possible to generate 12-bit gradation with 16 sub-frames, even if driving is carried out at four times speed. If this were realized with single pixels, it would require 12×4=48 sub-frames, and driving would have to be carried out at three times the speed compared to the case shown in FIG. 9.

It is necessary to increase the number of lines to make display higher resolution, and it is necessary to reduce the selection period for one line. Also, since wiring loss is increased if a large screen is made, it is not possible to shorten the select time of a single line. Therefore, if high resolution and large screen size are implemented, increase in sub-frames becomes difficult, and it is extremely difficult to include 48 sub-frames to generate four times speed 12-bit gradation. However, if three sub-pixels are introduced, it is possible to realize four times speed 12-bit gradation in 16 sub-frames, and so sufficient driving becomes possible even with higher resolution and a large screen.

In the case where it is not possible to provide three sub-pixels, it is preferable to provide two sub-pixels. If sub-frame 1-1 is made the upper 4 bits and sub-frame 1-2 is made the lower 4 bits, and bit data is divided in two, namely into upper order bits and lower order bits, it is possible to achieve 8-bit gradation in 16 sub-frames (four sub-frames in a unit frame). If it is possible to introduce four sub-pixels, since they are divided into upper bits, middle upper bits, middle lower bits and lower bits, it is possible to achieve 12-bit gradation with 12 sub-frames (three sub-frames in a unit frame).

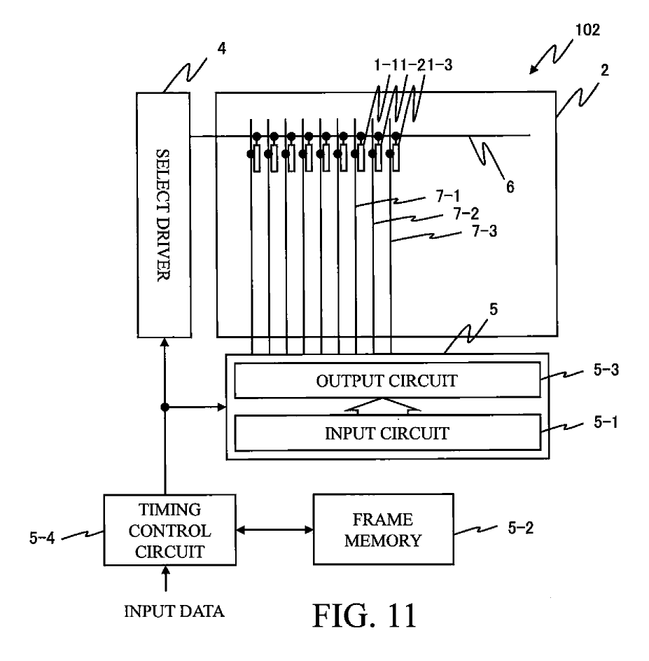

Overall structure of a display device 102 containing the pixels of FIG. 9 is shown in FIG. 11. Structural elements having the same reference numerals perform the same operations as in FIG. 1, and so description is omitted. With the display device 102, three sub-pixels 1-1 to 1-3 are provided for a unit pixel, there are data lines 7-1 to 7-3 corresponding to these pixels, and the number of data lines becomes three times that of the display device 101. It is therefore necessary for the number of outputs of the data driver 5 to also correspond to this increased number of data lines.

Since it is assumed that the display device 101 is a large type, the multiplexor 3 that was provided in the display device 101 is omitted. This is because if the multiplexor 3 were to be provided, high-speed drive would not be possible due to the on resistance of the multiplexor 3. Specifically, the data lines 7-1 to 7-3 are directly connected to outputs of the data driver 5. The data driver 5 therefore secures a number of outputs for a data lines sufficient for data lines 7-1 to 7-3 for each of RGB. For example, in the case of full Hi-Vision, the horizontal resolution is 1920, and so the number of outputs of the data driver 5 is 1920×3(RGB)×3=17280. Supplying only this number of outputs with a single driver IC is not common practice, but with a plurality of ICs this number of outputs is possible. For example, with a 720 output driver IC, 14 driver ICs would suffice. The data driver 5 is constructed of only a simple digital circuit including an output circuit 5-3 provided with the same number of outputs as there are data lines of the display array 2, and an input circuit 5-1 for converting dot unit data input to the data driver into line units. It is therefore easy to reduce cost even if there are three times as many outputs. Also, since the frame memory is provided outside the data driver 5, it is possible to use low cost general-purpose components. It is also possible to use a built-in memory type data driver such as shown in FIG. 1 as the data driver, if it is possible to provide a frame memory at low cost.

Dot unit data input from outside is first input to the timing control circuit 5-4, and after analysis by a built in data analysis circuit 5-5 to determine the extent to which critical transitions exist within the input image, a refresh rate appropriate for the image is set in the refresh rate control circuit. Refresh rate control due to critical transitions at this time is carried out in the same way as described previously, and in this transition period also control is carried out so as to change the refresh rate smoothly. The refresh rate control circuit 5-6 generates each timing signal at the set refresh rate, and supplies the timing signals to the data driver 5, frame memory 5-2 and select driver 4.

Input data is stored in the temporary frame memory 5-2, by way of the timing control circuit 5-4, and if the sub-frame as shown in FIG. 10 commences bit data corresponding to that sub-frame is read out and input by way of the timing control circuit 5-4 to the data driver 5. For example, in the case where the data is 12 bits, if SF2 commences bit 10, bit 6 and bit 2 data written to each sub-pixel of a corresponding line is read from the frame memory 5-2, and transferred to the input circuit 5-1. The input circuit 5-1 stores data for a line of each sub pixel that is input in dot units, in single line portions, converts to line data, and transfers the line data to the output circuit 5-3. The output circuit 5-3 supplies line data from the input circuit 5-1 to data lines 7-1 to 7-3 of each sub-pixel in line units, and bit data corresponding to the sub-frame is written to pixels of a line selected by the select driver 4. Specifically, here data of bit 10, bit 6 and bit 2 of SF2 are written to respective sub-pixels 1-1, 1-2 and 1-3. This operation is repeated for each line and each sub-frame, as shown in FIG. 10, double speed driving is carried out at a timing generated by the refresh rate control circuit 5-6, to suppressing pseudo contours while maintaining multiple gradations.

The structure of this embodiment as described above is not limited to an organic EL display, and it goes without saying that it can also be applied to situations where driving in a self emissive display is performed with digital diving, such as a plasma display or field emission display having comparatively fast response, or an inorganic EL display.

The invention has been described in detail with particular reference to certain preferred embodiments thereof, but it will be understood that variations and modifications can be effected within the spirit and scope of the invention.

### PARTS LIST

1 pixels
1-1 subpixel
1-2 subpixel
1-3 sub-pixel
2 pixel array
3 multiplexor
4 select driver
5 data driver
5-1 input circuit
5-2 frame memory
5-3 output circuit
5-4 timing control circuit
5-5 analyzing circuit
5-6 rate control circuit
6 select lines
7 data lines
7-1 data line
7-2 data line
7-3 data line
8 power supply line
8-1 power supply line
8-2 power supply line
8-3 power supply line
9 cathode electrode
10 organic EL element
10-1 organic EL element
10-2 organic EL element
10-3 organic EL element

### PARTS LIST CONT'D

11 drive transistor
12 select transistor
13 storage capacitor
101 display device

1. A method for driving an electroluminescent display, comprising:
(a) providing the electroluminescent (EL) display having a pixel array having a plurality of pixels arranged in a matrix, a plurality of select lines arranged for each line of pixels and a plurality of data lines arranged for each column of pixels, a select driver for selectively driving the select lines, and a data driver for driving the data lines, wherein each pixel includes an organic EL element and a drive transistor for causing current to flow into the organic EL element to cause it to emit light;
(b) receiving an image having input data for each pixel;
(c) dividing the input data for each pixel into a plurality of bit data values for a plurality of sub-frames, respectively);
(d) analyzing the input data for the image to detect critical transition (CT) pixels for which pseudo contours occur with line of sight movement;
(e) selecting a refresh rate based on the detected critical transition pixels; and
(f) providing the bit data of the plurality of sub-frames sequentially to the respective pixels during one or more unit frame period(s) to cause the pixel array to display images at the selected refresh rate, wherein the unit frame period(s) corresponds to the refresh rate).

2. The method of claim 1, wherein step (d) further includes calculating a level of CT pixels by dividing the number of detected CT pixels by the number of pixels in the plurality of pixels, and wherein step e further includes increasing the refresh rate when the level of CT pixels exceeds a selected percentage).

3. The method of claim 1, wherein step (d) includes
(i) performing an OR or exclusive-or (XOR) operation on the respective bit data values of a selected first pixel and a selected second pixel peripheral to the first pixel; and
(ii) comparing the result of the OR or XOR operation to the respective bit data values of the selected first pixel and selected second pixel, and detecting a CT pixel if the result of the OR or XOR operation has greater than a selected difference from the respective bit data values of the selected first pixel and selected second pixel.

4. The display device of claim 1, wherein each pixel includes a plurality of sub-pixels, and respective different bit data values of the pixel are provided to each sub-pixel during each sub-frame.
